(19) United States
(12) Patent Application Publication
(10) Pub. No.: US 2013/0335981 A1
(43) Pub. Date: Dec. 19, 2013

(54) ELECTRIC NOVELTY LAMP SILHOUETTING A HUMAN LEG FORM

(71) Applicant: Jonathan Paul Woerner, Raymore, MO (US)

(72) Inventor: Jonathan Paul Woerner, Raymore, MO (US)

(21) Appl. No.: 13/912,154

(22) Filed: Jun. 6, 2013

Related U.S. Application Data
(60) Provisional application No. 61/659,968, filed on Jun. 14, 2012.

(51) Int. Cl. F21V 1/00

(52) U.S. Cl. CPC F21V 1/00
USPC 362/351

(57) ABSTRACT

A lamp light installed on top of a human leg form, when turned on by electricity, illuminates a lamp shade and provides a silhouette of the human leg form and high heel shoe with a fishnet stocking. This keeps the human leg form cooler and will not create heat to melt or create fire or burn injury. The lamp includes a large base, where the human leg form and high heel shoe is attached, to distribute weight more evenly and reduce the possibility of the lamp tipping over on its side.

### CROSS-REFERENCE TO RELATED APPLICATION

This application claims the benefit of priority of U.S. provisional application No. 61/659,968, filed Jun. 14, 2012, the contents of which are herein incorporated by reference.

### BACKGROUND OF THE INVENTION

The present invention relates to electric novelty lamps and, more particularly, to an electric novelty lamp silhouetting a human leg form, fishnet stockings, and a high heel shoe.

Conventional novelty lamps often dispose a lamp inside of a design, often made of plastic, fiberglass or glass. This design can cause fire or a burn injury to an individual holding or moving the lamp, as a lamp installed inside a container that has little if any ventilation can become very hot.

As can be seen, there is a need for an improved novelty lamp silhouetting a human leg form that is not a burn or fire hazard.

### SUMMARY OF THE INVENTION

In one aspect of the present invention, a novelty lamp comprises a base member; a high heel shoe attached to the base member; a human leg form extending from the high heel shoe; a lamp kit bracket disposed outside of the human leg form, on a top leg member disposed on a top end of the human leg form; and a lamp shade covering the lamp kit bracket.

In another aspect of the present invention, a novelty lamp comprises a base member; a high heel shoe attached to the base member, the base member having a length longer than the high heel shoe; a human leg form extending from the high heel shoe; a lamp kit bracket disposed outside of the human leg form, on a top leg member disposed on a top end of the human leg form; a lamp socket supporting a light bulb, the lamp socket disposed outside the human leg form; a lamp shade covering the lamp kit bracket; a fringe disposed about a lower periphery of the lamp shade; and an electrical cord passing through a hole in the base member, through a hole in the high heel shoe, and through a hole in the human leg form, and extending through the entirety of the human leg form to terminate at the lamp socket.

These and other features, aspects and advantages of the present invention will become better understood with reference to the following drawings, description and claims.

### BRIEF DESCRIPTION OF THE DRAWINGS

FIG. 1 is a front view of a human leg form lamp according to an exemplary embodiment of the present invention;

FIG. 2 is a top view of the human leg form lamp of FIG. 1;

FIG. 3 is a bottom view of the human leg form lamp of FIG. 1;

FIG. 4 is an exploded perspective view of the human leg form lamp of FIG. 1;

FIG. 5 is a rear view of the human leg form lamp of FIG. 1; and

FIG. 6 is a detailed, partial cross-sectional view of section 6-6 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a lamp light installed on top of a human leg form that, when turned on by electricity, illuminates a lamp shade and provides a silhouette of the human leg form and high heel shoe with a fishnet stocking. This keeps the human leg form cooler and will not create heat to melt or create fire or burn injury. The lamp includes a large base, where the human leg form and high heel shoe is attached, to distribute weight more evenly and reduce the possibility of the lamp tipping over on its side.

A lamp light installed outside of the leg form is a cooler method of producing a silhouette of the leg form and high heel shoe with fishnet stocking, as compared to conventional novelty lamps where the lamp is placed inside the leg form. This feature, along with the larger base member, prevents fire, melt, burn and tipping hazards for the lamp.

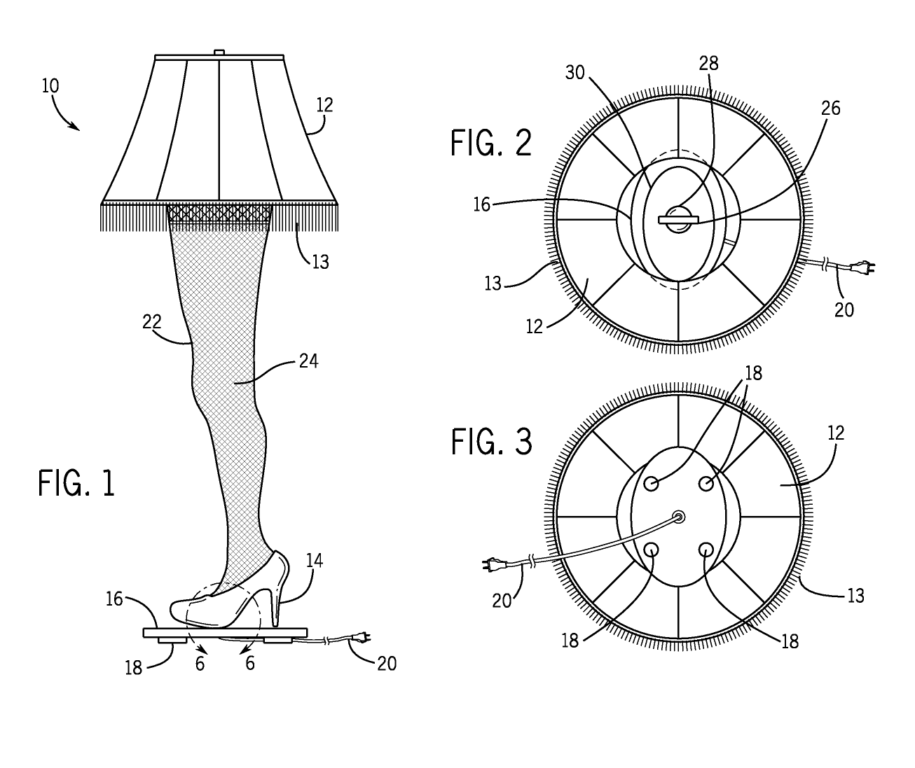

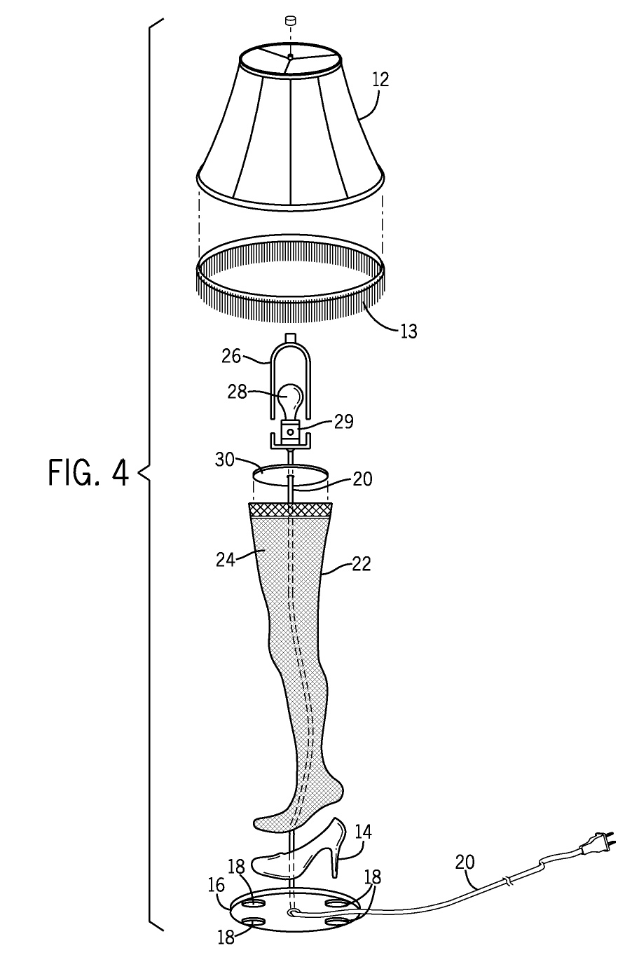

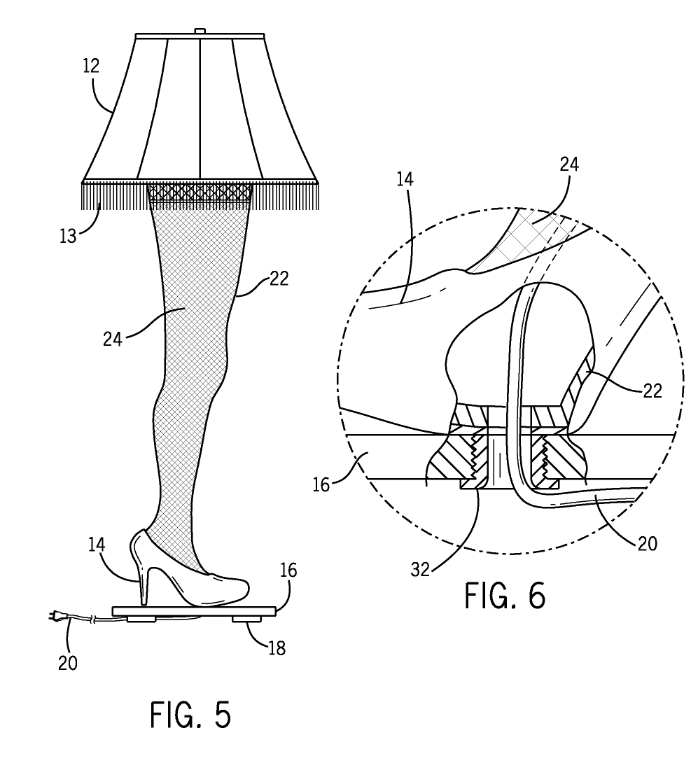

Referring now to FIGS. 1 through 6, a human leg form lamp 10 can be supported by a base 16. The base 16 can be formed in various shapes, typically oval, and can be formed from various materials, typically a heavy, solid material, such as wood, to provide support for the lamp 10. The base 16 can be sized large enough to provide adequate support for the lamp. For example, the base 16 can be from about 8-10 inches wide, typically about 9 inches wide, and from about 10-14 inches long, typically about 12 inches long.

Three or more feet 18, typically four feet 18, can be attached to the base 16 on a bottom side thereof. The feet 18 can be attached in various manners, such as with screws, an adhesive, or the like. The base 16 can be stained with, for example, golden oak or some other wood stain. The color can be sealed with polyurethane clear gloss, for example.

An all-thread, nipple or bushing 32, typically about 1½ inches in length can be attached into a hole in the base 16. In some embodiments, the bushing 32 can be attached to a connection plate or electrical crossbar, typically about 4 inches in length with #6×⅝ inch Phillips or straight head wood screws, in a typically ⅜ inch pre-drilled hole in the wooden base 16. A plastic, fiberglass, or some other material human leg form 22 about 28½ inches in length can be fit into a 3½ inch, 4 inch or 4½ inch high heel shoe 14, such as a black high heel shoe, to the wooden base 16. A fishnet stocking design 24 can be disposed over all or some of the human leg form 22.

The leg form 22 with the shoe 14 can be attached to the base 16. A 1/2 inch hole, for example, can be drilled into the wooden base 16, shoe 14 and leg form 22. The leg form 22 and shoe 14 can be removed and a fishnet hose or stocking 24 with lace can be attached to the leg form 22. The leg form 22 can be re-attached back to the shoe 14 on to the wooden base 16.

A ⅜ inch hole, for example, can be drilled into a leg top member 30, such as a wooden leg top member typically about 6 inches in width by about 6½ inches in length, and typically about ¼ inch thick. A 3-way or single lamp kit, including a socket 29, harp 26, and light bulb 28, can be installed to the human leg form 22 and the wooden leg top member 30. A bullion, such as a black bullion about 2½ inches or 3 inches of fringe 13 can be attached to, for example, a beige or cream color bell shaped lamp shade 12. The lamp shade 12 can be attached to leg form with the harp 26 attached and glued with the wooden leg top member 30 to the leg form 22.

The fishnet hose or stockings 24 can be pulled up to the wooden leg top member 30. The name, number, and signed signature of the patent holder can be displayed on the bottom of wooden base 16, for example. The finished product can be about 42 inches in height, allowing the lamp to ship in two card board boxes—one for the bell shape lamp shade and one for the finished product.

The finished product provides a novelty lamp of a human leg form, where the lamp is disposed outside of the leg form, as opposed to inside the leg for as is conventionally performed with novelty lamps.

It should be understood, of course, that the foregoing relates to exemplary embodiments of the invention and that modifications may be made without departing from the spirit and scope of the invention as set forth in the following claims.

What is claimed is:

1. A novelty lamp comprising:
a base member;
a high heel shoe attached to the base member;
a human leg form extending from the high heel shoe;
a lamp kit bracket disposed outside of the human leg form, on a top leg member disposed on a top end of the human leg form; and
a lamp shade covering the lamp kit bracket.

2. The novelty lamp of claim 1, further comprising a lamp socket supporting a light bulb, the lamp socket disposed outside the human leg form.

3. The novelty lamp of claim 1, further comprising a fringe disposed about a lower periphery of the lamp shade.

4. The novelty lamp of claim 1, wherein the base member is larger than a length of the high heel shoe.

5. The novelty lamp of claim 1, further comprising a plurality of feet disposed on a bottom side of the base member.

6. The novelty lamp of claim 2, wherein an electrical cord passes through a hole in the base member, through a hole in the high heel shoe, and through a hole in the human leg form, and extends through the entirety of the human leg form to terminate at the lamp socket.

7. A novelty lamp comprising:
a base member;
a high heel shoe attached to the base member, the base member having a length longer than the high heel shoe;
a human leg form extending from the high heel shoe;
a lamp kit bracket disposed outside of the human leg form, on a top leg member disposed on a top end of the human leg form;
a lamp socket supporting a light bulb, the lamp socket disposed outside the human leg form;
a lamp shade covering the lamp kit bracket;
a fringe disposed about a lower periphery of the lamp shade; and
an electrical cord passing through a hole in the base member, through a hole in the high heel shoe, and through a hole in the human leg form, and extending through the entirety of the human leg form to terminate at the lamp socket.

8. The novelty lamp of claim 7, further comprising a plurality of feet disposed on a bottom side of the base member.
